(19) United States
(12) Patent Application Publication
(10) Pub. No.: US 2005/0224015 A1
(43) Pub. Date: Oct. 13, 2005

(54) Animal waste collecting device

(76) Inventor: Renee Gamache, DRUMMONDVILLE, QUEBEC (CA)

Correspondence Address: Renee Gamache, 5095 Geremi, Quebec, J2E 1M1, CA

(21) Appl. No.: 10/512,550

(22) PCT Filed: Apr. 25, 2003
(86) PCT No.: PCT/CA03/00608

§ 371 Date: Oct. 25, 2004

(30) Foreign Application Priority Data
Apr. 25, 2002 (GB) 0209400.1

(51) Int. Cl. A01K 23/00

(52) U.S. Cl. 119/868

(57) ABSTRACT

A collecting device for collecting animal waste includes a collecting component defining a generally pouch-like container section for receiving the animal waste and a flange-like mounting section extending integrally from the container mouth for mounting the collecting component to the animal. The mounting section defines a tail abutment edge positionable adjacent the tail of the animal. An attachment strap is attachable to the collecting component for releasably securing the collecting component to the animal. A handle and a tab both extend from the mounting section and are usable both for manipulating the collecting component to and for closing the latter once the animal waste has been collected.

### FIELD OF THE INVENTION

The present invention relates to the general field of animal care accessories and is particularly concerned with an animal waste collecting device.

### BACKGROUND OF THE INVENTION

Household pets such as dogs, cats and the like are very popular in some regions of the world. These pets, traditionally found in rural areas in which they may be left relatively unattended, are now becoming increasingly popular in suburban neighborhoods and even in some urban areas.

With the increasing number of pets and especially of dogs in urban residential areas, there is a concomitant increased need for a solution to the problem of animal excrement littering public places. Indeed, body waste residuals scattered in public places creates an unhealthy and unpleasant environment.

Accordingly, in some areas of the world, municipal bylaws now prescribe relatively hefty fines for dog owners and/or caretakers leaving excrements in public places such as parks, lawns, sidewalks, alleyways and the like. Some regulations prohibits the presence of dogs altogether in certain areas including a large number of indoor public areas such as hotels, stores, bus or railroad terminals and the like.

Hygienic problems associated with dog excrements are not limited to public places but also face dog owners/takers in their own settings. For example, many dogs upon reaching old age lose control over some of their bodily functions. These older dogs may urinate and even defecate while indoors or while traveling via automobile or other mode of transportation. The same problem arises with younger dogs that have not yet learned to control their bodily functions. Furthermore, female dogs may lose menstrual fluids during their menstrual period for most of their reproductive life.

Dog urine is known to contain chemical ingredients that may have a harsh effect upon contacting various fabrics, including fabrics that are used in rugs and furniture coverings. Also, blood from menstruation fluids may cause stains that are difficult if not impossible to remove using conventional cleaning methods. Still further, animal blood, urine or feces discharge typically produces lingering unpleasant odors and relatively unsanitary conditions in occupied quarters.

One approach to the problem associated with in-house animal waste is to provide the dog with a conventional dog toilet. However, the dog requires training in order to use the toiled which may be time consuming and laborious. Furthermore, the use of dog toilets does not take away the need for cleaning and often only provides partial results. Furthermore, dog toilets have proven to be totally unsatisfactory for circumventing problems associated with menstrual losses.

A conventional solution to the problem associated with outdoor littering by dog excrement as been to follow the animal until the latter drops excrement in a public place. The droppings are then scooped using a scoop or a shovel and carry to a suitable discharge location. This conventional solution is however marginally effective, tedious and often most unpleasant for the person performing the actual scooping and carrying and for other individuals nearby. Furthermore, because the operation is typically unpleasant, animal owners/care givers may intentionally or inadvertently fail to be diligent in performing their duties.

It seems apparent from the lack of solutions in reference to both in-house and outdoor littering by animal excrements that there exists a need for providing a means of preventing the soiling of areas in the first place prior to requiring cleaning of the excrements. The prior art has shown some examples of devices specifically adapted to collect the excrements prior to requiring cleaning the latter from surfaces.

However, most prior art devices suffer from numerous drawbacks. Indeed, most prior art devices suffer from being generally cumbersome and uncomfortable. Some of the prior art devices interfere with the bodily movement of the animals. Others have proven to be impractical and/or ineffective. Accordingly, there exists a need for an improved animal excrement collecting device.

### SUMMARY OF THE INVENTION

In accordance with the present invention, there is provided 1. A collecting component for collecting animal waste, the collecting component being wearable by an animal having a tail, an anus, a tail root region extending between the tail and the anus, a perineum, a genital area, a pair of groin area, a pair of thighs, a hip area, a pubic area, a rump area, a loin area and an abdomen area; the collecting component being attachable to the animal using an attachment strap, the collecting component comprising: a collecting component body made out of a substantially flexible material; the collecting component body defining a generally pouch-like container section for receiving the animal waste, the container section defining a container mouth leading thereinto, the collecting component body also defining a flange-like mounting section extending integrally from the container mouth for mounting the collecting component to the animal so as to collect at least part of the animal waste therefrom and so as to direct the at least part of the animal waste into the container section; the mounting section having a mounting aperture defining a mounting aperture peripheral edge; the mounting section peripheral edge being configured and sized for extending from the tail root region at least to the perineum so as to encompass at least the anus; the collecting component body also including a first tab extending integrally from the mounting section, the first tab defining a first tab base positioned so as to be located substantially adjacent the tail root region; a second tab extending integrally from the mounting section substantially opposite to the first tab, the second tab defining a second tab base; a main strap attachment means formed in the collecting component body adjacent the second tab base for attaching a segment of the attachment strap thereto; a pair of auxiliary strap attachment means formed in the collecting component body substantially adjacent the first tab base and spaced from each other for each attaching a corresponding segment of the attachment strap thereto; whereby the first and second tabs are adapted to be used for manipulating the collecting component body and are also adapted to be tied together for substantially closing the mounting aperture.

In accordance with the present invention there is also provided a collecting device for collecting animal waste, the collecting device being wearable by an animal having a tail, an anus, a tail root region extending between the tail and the anus, a perineum, a genital area, a pair of groin area, a pair of thighs, a hip area, a pubic area, a rump area, a loin area and an abdomen area; the collecting device comprising: a collecting component defining a generally pouch-like container section for receiving the animal waste, the container section defining a container mouth leading thereinto, the collecting component body also defining a flange-like mounting section extending integrally from the container mouth for mounting the collecting component to the animal so as to collect at least part of the animal waste therefrom and so as to direct the at least part of the animal waste into the container section; the mounting section being configured and sized so as to define a tail abutment edge for abutting against a portion of the tail root region; an attachment strap attachable to the collecting component for releasably securing the collecting component to the animal.

Typically, the attachment strap is configured and sized for securing the collecting component to the animal so that the mounting section encompasses the anus and the tail abutment edge is in a substantially proximal relationship with the base of the tail.

Conveniently, the tail abutment edge has a substantially “V”-shaped configuration defining an abutment edge apex and a pair of abutment edge arms extending from the abutment edge apex; the collecting component also including a main strap attachment means and a pair of auxiliary strap attachment means formed therein; the attachment strap defining a pair of strap arms, each of the strap arms defining a strap proximal end and a strap distal end; the attachment strap being attachable to the collecting component so that the strap proximal ends are attached to the main strap attachment means and each of the strap distal end is attached to a corresponding one of the auxiliary strap attachment means.

Typically, the attachment component and the attachment strap are configured and sized so that the strap proximal ends and the main strap attachment means are positioned substantially adjacent the pubic area while the strap distal ends and the auxiliary strap attachment means are located substantially adjacent the tail root area substantially on opposite sides of the tail when the collecting component is mounted on the animal using the attachment strap.

Advantages of the present invention includes that the proposed device allows for convenient and effective collecting and disposing of animal excrements. Furthermore, the proposed device is designed so as to be easily and quickly attachable and/or detachable in an operational position on the animal. Furthermore, the proposed device is specifically designed so as to be customizable to various animal sizes and shapes.

Still further, the device is designed so as to be generally comfortable and so as not to interfere with bodily movements of the animal. Still furthermore, the proposed device optionally provides gender specific features for optimizing the comfort and efficiency of the device depending on the gender of the animal.

Also, the proposed device is designed so as to be manufacturable through conventional forms of manufacturing using conventional materials so as to provide a device that will be economically feasible, long lasting and relatively trouble-free in operation.

### BRIEF DESCRIPTION OF THE DRAWINGS

Various embodiments of the present invention will now be disclosed, by way of example, in reference to the following drawings in which:

FIG. 1. in a perspective view, illustrates an animal waste collecting device in accordance with an embodiment of the present invention, the collecting device being shown mounted on a dog;

FIG. 2, in a side elevational view, illustrates the collecting component in accordance with an embodiment of the present invention, the collecting component being part of the collecting device as shown in FIG. 1;

FIG. 3, in a perspective view, illustrates a collecting component in accordance with an alternative embodiment of the present invention;

FIG. 4, in a perspective view, illustrates an attachment strap also in accordance with an embodiment of the present invention, the attachment strap being used for securing a collecting component to an animal such as shown in FIG. 1;

FIG. 5, in a partial top view with sections taken out, illustrates part of the relationship between an attachment strap, a collecting component and the croup portion of an animal when the collecting device in accordance with an embodiment of the present invention is mounted on an animal;

FIG. 6, in a perspective view, illustrates an attachment strap in accordance with an alternative embodiment of the present invention;

FIG. 7, in a partial top view with sections taken out, illustrates the strap shown in FIG. 6 mounted on the croup section of an animal;

FIG. 8, in a schematic side view, illustrates an animal waste collecting device in accordance with yet another alternative embodiment of the present invention, the collecting device being shown mounted on a dog and the dog being shown with half of its limbs removed therefrom;

FIG. 9, in a perspective view, illustrates a collecting component in accordance with an alternative embodiment of the present invention;

FIG. 10, in a perspective view, illustrates the collecting component in accordance with yet another alternative embodiment of the present invention;

FIG. 11, in a top view, illustrates a sanitary pad holder, also in accordance with an embodiment of the present invention;

FIG. 12, in a perspective view, illustrates a collecting component in accordance with still yet another alternative embodiment of the present invention;

FIG. 13, in a partial perspective view with sections taken out, illustrates a collecting component in accordance with another alternative embodiment of the invention, the collecting component being shown in full lines in a retracted configuration and in phantom lines in an expanded configuration;

FIG. 14, in a perspective view, illustrates a collecting component in accordance with yet another alternative embodiment of the invention, the collecting component being shown in a shrunken configuration;

FIG. 15, in an elevational view, illustrates a collecting component in accordance with an embodiment of the present invention, the collecting component being with animal waste contained therein and in a closed configuration;

FIG. 16, in a rear perspective view, illustrates a collecting component in accordance with an embodiment of the present invention, the collecting component being shown with its handle in a handle folded configuration;

FIG. 17, in a partial rear view with sections taken out, illustrates a collecting component in accordance with an embodiment of the present invention mounted on the rump section of an animal, the collecting component being shown without its handle section and with part of its mounting section extending in one of the groin areas of the animal;

FIG. 18, in a rear view with sections taken out, illustrates a collecting component in accordance with an embodiment of the present invention mounted on an animal, the collecting component being shown with its handle removed therefrom and with sections thereof extending on both sides of the genital area of the animal.

FIG. 19, in a partial perspective view, illustrates a main hook part of an attachment strap being attached to main attachment aperture part of a collecting component in accordance with an embodiment of the present invention;

FIG. 20, in a partial perspective view with sections taken out, illustrates part of an attachment strap being wrapped around the waist of an animal to which a collecting component is about to be attached;

FIG. 21, in a partial perspective view with sections taken out, illustrates the collecting component shown in FIG. 20 with its handle in a folded configuration being positioned in an operational position adjacent the tail of the animal;

FIG. 22, in a partial top view with sections taken out, illustrates the collecting component shown in FIGS. 19 through 21 with an auxiliary hook component part of a strap being attached to an auxiliary attachment aperture part of the collecting component;

FIG. 23, in a partial top view with sections taken out, illustrates the collecting component and strap shown in FIGS. 19 through 22 with the other auxiliary hook being attached to the other auxiliary attachment aperture part of the collecting component;

FIG. 24, in a partial top view with sections taken out, illustrates the collecting component and strap shown in FIGS. 19 through 23 with an insertable segment part of the attachment strap being inserted into a loop segment also part of the attachment strap;

FIG. 25, in a partial perspective view with sections out, illustrates the collecting component and strap shown in FIGS. 19 through 24 having animal waste contained therein and being removed from the animal.

### DETAILED DESCRIPTION

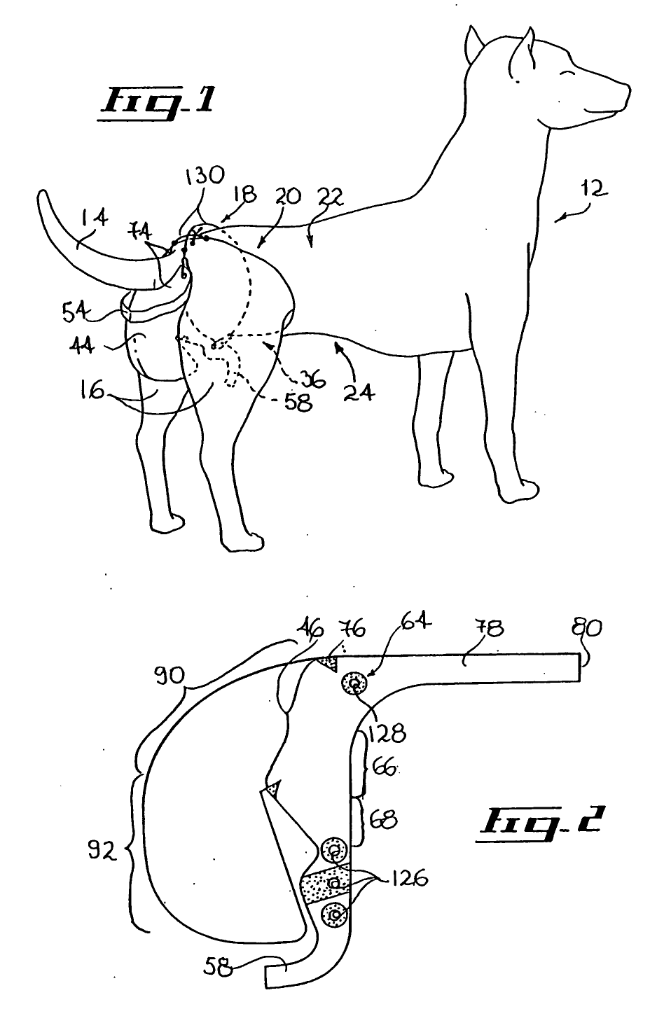

Referring to FIG. 1, there is shown an animal waste collecting device 10 in accordance with an embodiment of the present invention. The collecting device 10 is shown mounted on a dog 12. It should be understood that although the animal waste collecting device 10 is shown throughout the figures as being mounted on a dog 12, the device 10 could be used with other types of animals without departing from the scope of the present invention.

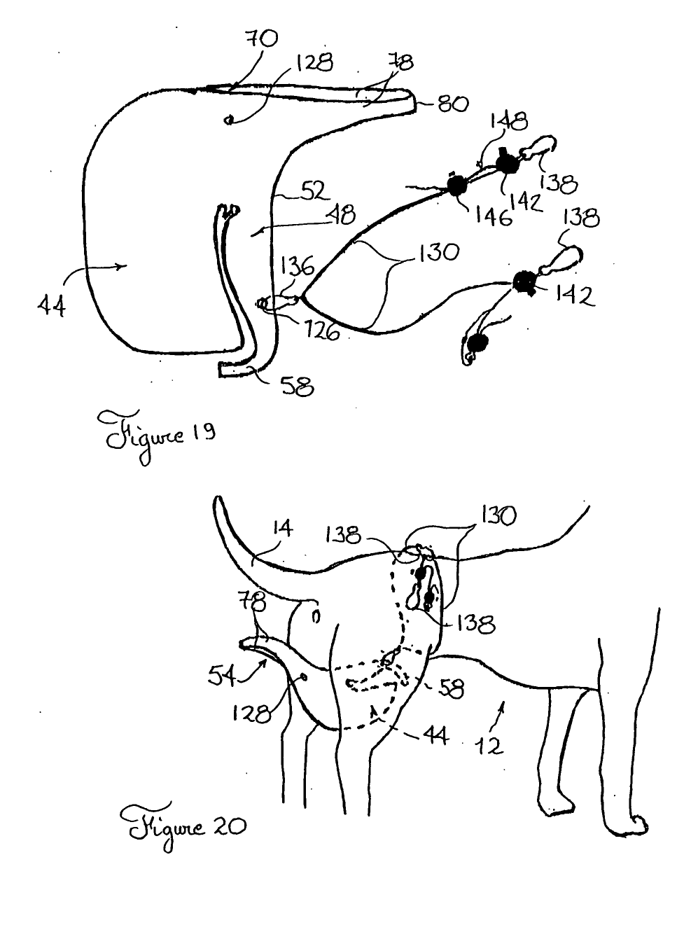

Typically, the animal 12 has a tail 14 and a pair of thighs 16, a rump area 18, a hip area 20, a loin area 22, a pubic area 36 and an abdomen area 24. As illustrated more specifically in FIGS. 17 and 18, the animal 12 also has an anus 26 and a tail root region 28 extending between the tail 14 and the anus 26. The animal 12 further has a pair of groin areas 30, a genital area 32 and a perineum 34 extending between the anus 26 and the genital area 32.

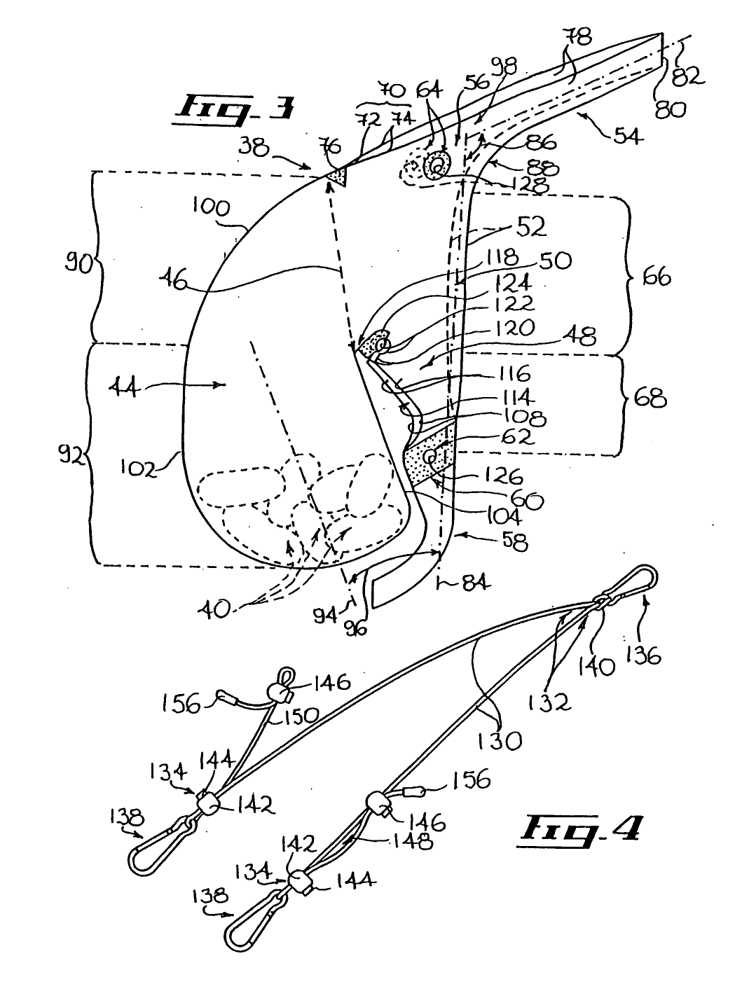

The collecting device 10 includes a collecting component 38 illustrated in greater detail in FIGS. 2, 3, 9, 10, and 12 through 15 for collecting animal waste such as animal feces 40 illustrated schematically and in phantom lines in FIGS. 3 and 15. Although only feces 40 are illustrated in FIGS. 3 and 15, it should be understood that the animal waste collecting device 10 could be used for collecting other types of animal waste such as urine, menstrual blood or the like depending on the type of embodiment of the invention being used without departing from the scope of the present invention.

As shown more specifically in FIGS. 1, 5, 7 and 8, the collecting component 38 is attachable to the animal 12 an attachment means such as an attachment strap 42. Although the attachment strap 42 is shown throughout the Figures as being the preferred attachment means, it should be understood that other types of attachment means could be used without departing from the scope of the present invention.

Referring now more specifically to FIG. 3, there is shown in greater details some of the features of a collecting component 38 in accordance with an embodiment of the present invention. The collecting component 38 includes a collecting component body made out of a substantially flexible material. The collecting component body defines a generally pouch-like container section 44 for receiving the animal waste 40. In turn, the container section 44 defines a container mouth 46 leading thereinto.

The collecting component body also defines a flange-like mounting section 48 extending integrally from the container mouth 46 for mounting the collecting component 38 to the animal 12 so as to collect at least part of the animal waste 40 therefrom and so as to direct the animal waste 40 into the container section 44. The mounting section 48 has a mounting aperture 50 defining a mounting aperture peripheral edge 52.

As illustrated more specifically in FIGS. 17 and 18, the mounting section peripheral edge 52 is configured and sized for extending from the tail root region 28 at least to the perineum 34 so as to encompass at least the anus 26. Typically, the mounting section peripheral edge 52 is configured and sized for extending from the tail root region 28 across the perineum 34 and the genital area 32 to the pubic area 36.

Referring back to FIG. 3, there is shown that the collecting component body typically also includes a first tab 54 extending integrally from the mounting section 48. The first tab 54 defines a first tab base 56 positioned so as to be located substantially adjacent the tail root region 28. The collecting component body also defines a second tab 58 extending integrally from the mounting section 48 substantially opposite to the first tab 54. The second tab 58 defines a second tab base 60.

The collecting component body further includes a main strap attachment means 62 formed therein substantially adjacent to the second tab base 60 for attaching a segment of the attachment strap 42 thereto. The collecting component body still further includes at least one and preferably a pair of auxiliary strap attachment means 64 formed therein substantially adjacent to the first tab base 56 and spaced from each other for each attaching corresponding segments of the attachment strap 42 thereto.

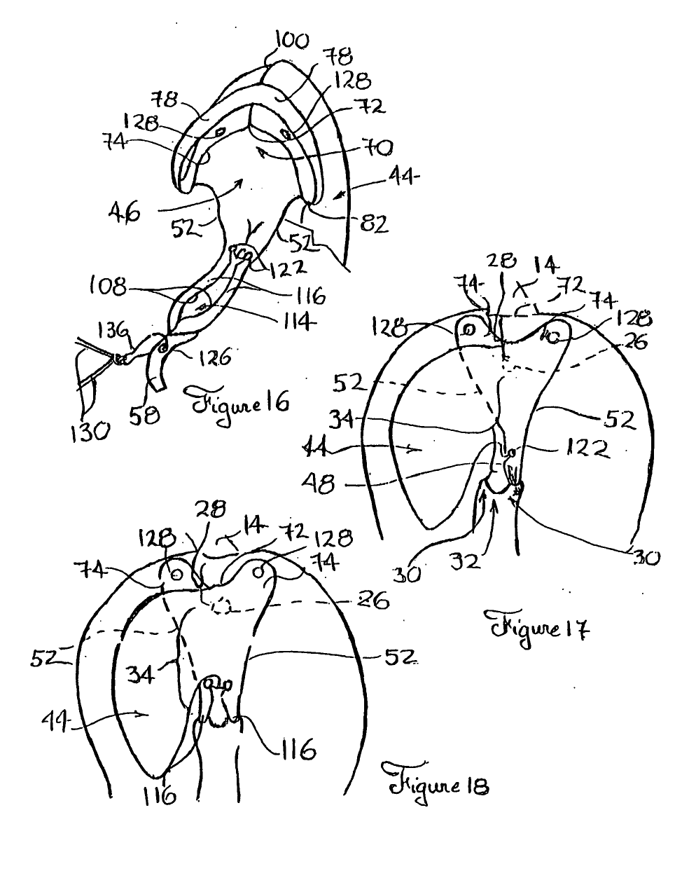

As illustrated more specifically in FIGS. 3 and 16 through 18, the mounting section 48 typically defines a mounting section first portion 66 configured and sized for extending substantially from the tail root region 28 substantially across the perineum 34 to substantially the genital area 32. The mounting section 48 also defines a mounting section second portion 68 configured and sized for extending substantially across the genital area 32 to the pubic area 36.

Typically, the mounting section 48 is configured and sized so as to define a tail abutment edge 70 for abutting against either a portion of the tail root region 28 or preferably against the base of the tail 14. As illustrated more specifically in FIGS. 3 and 16 through 18, the tail abutment edge 70 typically has a substantially U- or V-shaped cross-sectional configuration defining an abutment edge apex 72 and a pair of abutment edge arms 74 extending from the abutment edge apex 72.

Each of the auxiliary strap attachment means 64 is positioned on or adjacent to a corresponding abutment edge arm 74. Each of the auxiliary strap attachment means 64 is typically spaced from the abutment edge apex 72 so that when the collecting component 38 is mounted on the animal 12, the abutment edge apex 72 is positioned in a proximal or abutting relationship with the tail 14 and at least a portion of each of the abutment edge arms 74 is also in a proximal or abutting relationship relative to the tail 14 respectively on substantially opposite sides of the latter.

Typically, the tail abutment edge 70 is configured and sized so that the tail 14, adjacent its base, is substantially fittingly inserted in the V-shaped configuration formed by the abutment edge arms 74. With the tail 14 snuggly inserted between the abutment edge arms 74, the tail 14 helps to stabilize the collecting component 38 and also helps to maintain the container mouth 46 in an opened configuration. The V-shaped configuration of the tail abutment edge 70 further facilitates proper positioning and centering of the collecting component 38 when the latter is being mounted on the animal 12.

Typically, the collecting component 38 is further provided with an apex reinforcement means 76 positioned between the abutment edge apex 72 and the container mouth 46 for preventing the splitting open or tearing of the container mouth 46 upon a pressure being exerted by the tail 14 on the abutment edge apex 72. The apex reinforcement means may take any suitable form. For example, the apex reinforcement means may include a piece of reinforcement material affixed or embedded on or into the material from which the collecting component body is made. Alternatively, the apex reinforcement means may include a localized thickening of the material from which the collecting component body is made.

As illustrated more specifically in FIG. 3, the first tab 54 preferably takes the form of a loop-type handle defining a pair of handle arms 78 merging together about a distally located handle apex 80. Each of the handle arms 78 typically extends from a corresponding one of the abutment edge arms 74 about a corresponding abutment edge-to-handle transition area 82.

The handle 54 is preferably foldable about the abutment edge-to-handle transition area 82 between a handle folded configuration shown in FIGS. 1, 7, 8, and 16 and handle unfolded configuration shown in FIGS. 2, 3, 9, 10, and 12 through 14. When the handle 54 is in the handle folded configuration, the handle arms 78 are allowed to cross over the abutment edge arms 74 while the loop handle 54 is positioned in a substantially overlying relationship relative to the container section 44. The loop handle 54 is hence readily available for facilitating handling of the collecting component 38 both when the collecting component 38 is mounted on the animal 12 and when the collecting component 38 is away from the animal 12.

As illustrated in FIG. 15, the loop handle 54 is also adapted to be used in conjunction with the second tab 58 for substantially closing the mounting aperture 50 and preventing the animal waste 40 from falling out of the collecting component 38 when the loop handle 54 and the second tab 58 are tied together. Typically, the loop handle 54 still facilitates handling and transportation of the collecting component 38 when tied into a knot with the second tab 58. Hence, the loop handle 54 further facilitates transportation of the collecting component 38 when the latter contains animal waste such as feces 40 being transported to a discarding location.

As illustrated more specifically in FIG. 3, the loop arms 78 typically extends substantially along a handle axis 82 when the loop handle 54 is in the handle unfolded configuration. Also the mounting aperture peripheral edge 52 typically extends substantially along a peripheral edge axis 84. The handle and peripheral edge axes 82, 84 define a handle-to-peripheral edge angle 86 therebetween. The handle-to-peripheral edge angle 86 typically has a value of approximately between 90 and 170 degrees. The handle-to-peripheral edge angle 86 preferably has a value of approximately 120 degrees.

The handle 54 and the mounting aperture peripheral edge 52 together define a handle-to-peripheral edge intersection 88 therebetween. Typically, the handle-to-peripheral edge intersection 88 has a substantially concave and rounded configuration. The substantially concave and rounded configuration of the handle-to-peripheral edge intersection 88 is intended to substantially conform to the generally rounded and convex configuration of the rump area 18, hence enhancing comfort for the animal. The substantially concave and rounded configuration of the handle-to-peripheral edge intersection 88 is also intended to reduce the risks of the collecting component body being torn or spitted about the handle-to-peripheral edge intersection 88.

As illustrated in FIG. 2, in at least one embodiment of the invention, at least two main strap attachment means 62 are formed substantially adjacent to the second tab base 60. The main strap attachment means 62 are spaced relative to each other in a direction substantially parallel to the peripheral edge 84 to allow for some degree of customization depending on the morphological characteristics of the animal 12.

As illustrated more specifically in FIG. 3, the container section 44 typically defines a guiding region 90 extending from the container mouth 46. In turn, the guiding region 90 typically extends in a flow-wise direction into a retaining region 92. The retaining region 92 is typically located substantially underneath the guiding region 90 when the collecting component 38 is mounted on the animal 12. The guiding region 90 is adapted to guide the animal waste 40 into the retaining region 92 while the retaining region 92 is adapted to retain the animal waste 40 thereinto.

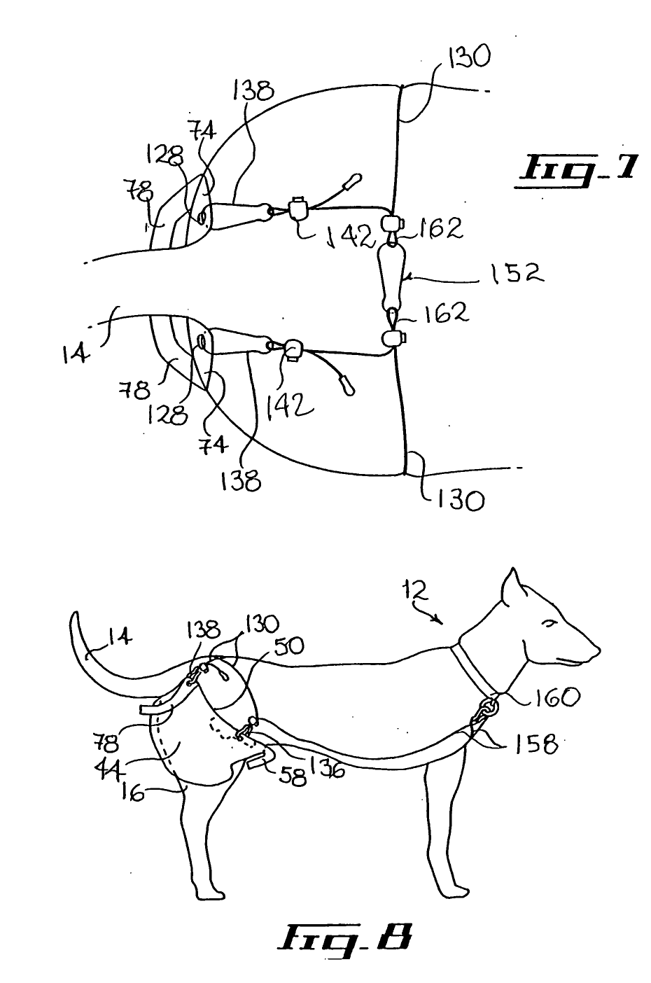

As shown more specifically in FIGS. 1 and 8, the guiding and retaining regions 90, 92 are preferably configured and sized so that the retaining region 92 extends at least partially between the thighs 16 of the animal 12 when the collecting component 38 is mounted on the animal 12. Typically, the retaining region 92 extends substantially along a retaining section axis 94. The peripheral edge and retaining section axes 84, 94 are angled relative to each so as to define a peripheral edge-to-retaining section angle 96 therebetween.

Typically, although by no means exclusively, the peripheral edge-to-retaining section angle 96 has a value of approximately between 5 and 80 degrees. Preferably, the peripheral edge-to-retaining section angle 96 has a value of approximately 45 degrees.

The peripheral edge-to-retaining section angle 96 is adapted to minimize the size of the portion of the collecting component 38 that protrudes rearwardly from the rump region 18 of the animal 12. The peripheral edge-to-retaining section angle 96 hence allows for a more aesthetically pleasing collecting component 38. Also, the peripheral edge-to-retaining section angle 96 allows the retaining region 92 to retain a relatively large volume of animal waste 40 without requiring the retaining region 92 extend downwardly between the thighs 16 along a substantial distance. This, in turn, reduces the risks of having the collecting component 38 considered by the animal 12 as being cumbersome. Furthermore, the peripheral edge-to-retaining section angle 96 allows for a substantial portion of the retaining region 92 to extend between the thighs 16 hence stabilizing the collecting component 38 against lateral swaying when the animal 12 is in motion.

The guiding region 90 defines a rearwardmost located guiding region outer edge 100. The guiding region outer edge 100 typically extends integrally from the apex reinforcement means 76 to a position located in a substantially opposed relationship relative to the container mouth 46. Typically, the guiding region outer edge 100 has a substantially rounded configuration.

Similarly, the retaining region 92 defines a retaining region outer edge 102 extending integrally from the guiding region outer edge 100. The retaining region outer edge 102 typically has a substantially rounded configuration. In at least some embodiments of the invention, the retaining region 92 typically also defines a retaining region inner edge 104 located substantially opposite to the mounting section second portion 68 and to a portion of the second tab 58. The retaining region inner edge 104 typically extends substantially from the retaining region outer edge 102 to the container mouth 46 and typically has a substantially rectilinear configuration.

In at least some embodiments of the invention shown more specifically in FIGS. 12 through 14, the container section 44 is designed so as to be deformable by the animal waste 40 as the latter penetrates into the container section 44. The container section 44 is deformable from a container retracted configuration to a container expanded configuration wherein the volume of the container section 44 is smaller when the container section 44 is in the container retracted configuration than when the container section 44 is in the expanded configuration.

FIG. 12 illustrates an embodiment of the invention wherein the container section 44 is foldable substantially about one of its edges into the container retracted configuration. The container section 44 is shown with the guiding region outer edge 100 and part of the retaining region outer edge 102 folded inwardly. It should be understood that other portions of the container section 44 could be folded inwardly or in other configurations such as on themselves without departing from the scope of the present invention.

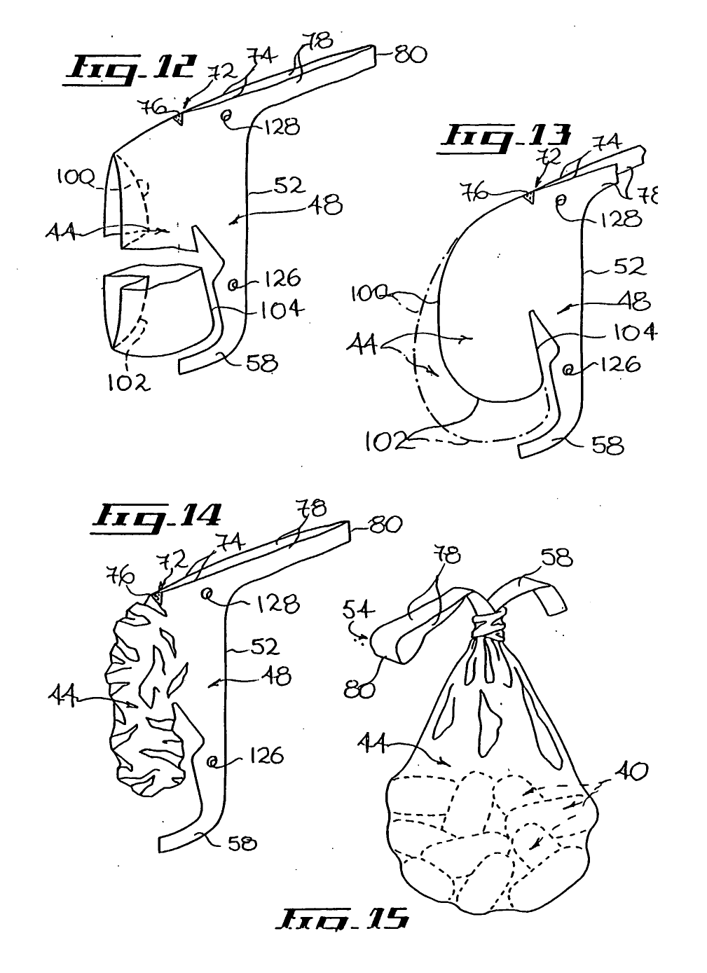

FIG. 13 illustrates an embodiment of the invention wherein the container section 44 is made out of a substantially resiliently deformable material. For example, the container section 44 could be made out of an elastomeric resin or the like. The container retracted configuration is shown in full lines while the container expanded configuration is shown in phantom lines. As animal waste 40 penetrates into the container section 44, the weight and bulk of the animal waste 40 is adapted to distend the resiliently deformable material from which the walls of the container section 44 are made.

FIG. 14 illustrates an embodiment of the invention wherein at least part of the walls of the container section 44 are wrinkled so as to form wrinkles 106 therein when the container section 44 is in the container retracted configuration. As animal waste 40 penetrates into the container section 44, the weight and bulk of the animal waste 40 deploys or flattens the wrinkles 106 hence increasing the volume of the container section 44 to that of the container expanded configuration.

In some embodiments of the invention, the mounting section second portion 68 is in fluid communication with the container section 44 for allowing animal waste originating from the genital area 32 to flow into the container section 44. In other embodiments of the invention, the mounting section second portion 68 is in fluid communication with the exterior or the collecting component 38 for allowing animal waste originating from the genital area 32 to flow out of the collecting component 38 and away from the animal 12.

Referring to FIGS. 1, 2, 9, and 12 through 14, there is shown that, in at least some embodiments of the invention, the mounting section 48 further defines a mounting section inner edge 108 located substantially opposite the mounting section peripheral edge 52 in the region of the mounting section second portion 68. In the embodiment shown in FIGS. 2, 9, 10, and 12 through 15, a mounting section inner edge 108 prevents the flow of animal waste therethrough.

In the embodiment shown in FIG. 9, the mounting section inner edge 108′ extends. substantially at right angle relative to the retaining region inner edge 104 hence allowing the mounting section second portion 68 to define an organ receiving pocket 110 for receiving an organ such as the penis of the animal 12. The organ receiving pocket 110 is in fluid communication with the retaining region 92 hence allowing fluids such as urine to flow into the retaining region 92.

Optionally, a liquid waste absorption means such as a sponge 112 or the like may be positioned or affixed into the retaining region 92 for absorbing the liquid waste and reducing the risks of having the liquid waste soil the animal 12 or unwantingly flow out of the container mouth 46 when the animal 12 is in motion.

FIG. 10 illustrates an embodiment specifically adapted for use with female animals for collecting both urine and feces. The embodiment shown in FIG. 10 is substantially deprived of a mounting section inner edge 108. The mounting section second portion 68 is in fluid communication with the retaining portion 92. The container mouth 46 allows through flow therethrough of both the feces 40 and urine (not shown) from the mounting section first and second portions 66, 68 into the container section 44. As with the embodiment shown in FIG. 9, a liquid waste retaining or absorbing means such as a sponge 112 or the like may be positioned or affixed into the retaining section 92 for retaining liquid animal waste.

In the embodiment shown in FIG. 3, the mounting section inner edge 108 is provided with an inner edge slot 114 extending therethrough. Typically, the inner edge slot 114 extends throughout the length of the mounting section inner edge 108. Alternatively, the inner edge slot 114 extends only partially across the mounting section inner edge 108. The mounting section second portion 68 hence defines a pair of second portion arms 116.

As illustrated more specifically in FIG. 18, each of the second portion arms 116 is positionable in a corresponding one of the groin areas 30 with at least a portion of the genital area 32 positionable substantially in register with the inner edge slot 114. The embodiment shown in FIG. 3 is adapted to be used with female animals wherein the genital area 32 includes the vulva of the animal. The inner edge slot 114 is particularly useful in situations wherein the vulva of the animal protrudes substantially outwardly either as part of a congenital variant or during specific periods of the menstrual cycle such as when the animal is in heat. The inner edge slot 114 allows the collecting component 38 to remain centered relative to the body of the animal 12. The inner edge slot 114 also allows urine to flow freely away from both the animal 12 and the collecting device 10.

Referring back to FIG. 3, there is shown that the retaining region inner edge 108 and the container mouth 46 typically define an inner edge-to-container mouth intersection 118 therebetween. A transversal slot 120 typically extends at an angle relative to the inner edge slot 114 substantially adjacent to the inner edge-to-container mouth intersection 118. The transversal slot 120 is adapted to prevent undue stresses from being imparted to the lips of the vulva of the female animal since it allows the second portion arms 116 to be more easily spread apart from each other.

Typically, the transversal slot inner edge is provided with a generally arcuate enlargement 122 for reducing the risks of being torn. Typically, the collecting device 10 is further provided with a mouth reinforcement means 124 located intermediate the container mouth 46 and the mounting section inner edge 108 for preventing the container mouth from being torn by forces imparted to the inner edge-to-container mouth intersection 108 when the device 10 is worn by the animal 12. Similarly to the apex reinforcement means 76, the mouth reinforcement means 124 may take any suitable form. For example, the mouth reinforcement means 124 may include a piece of reinforcement material affixed or embedded on or into the material from which the collecting component body is made. Alternatively, the mouth reinforcement means 124 may include a localized thickening of the material from which the collecting component body is made.

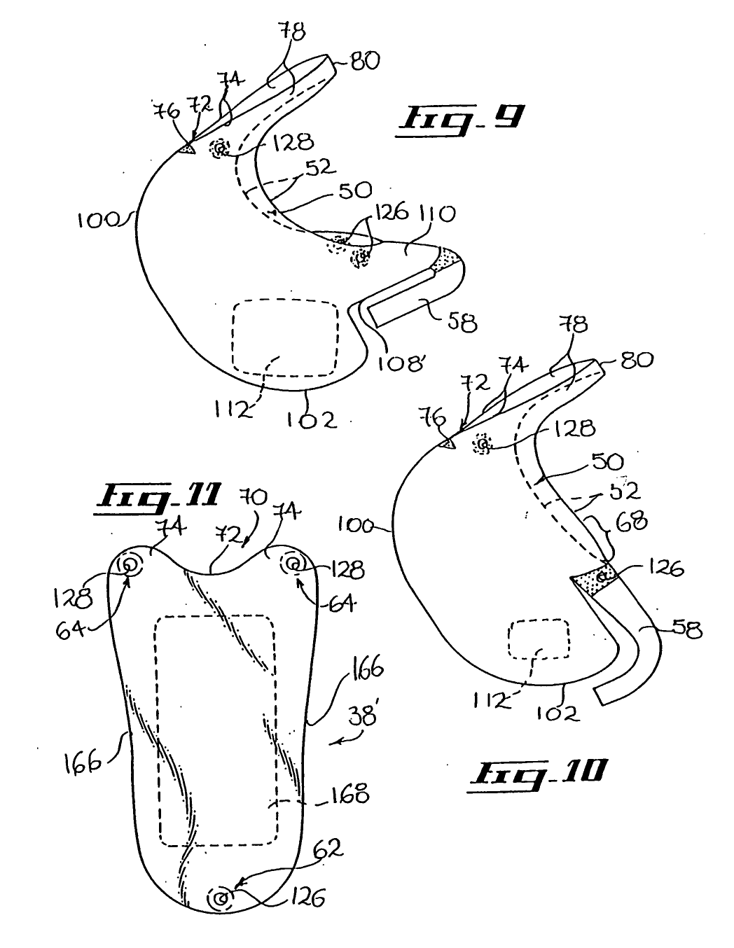

FIG. 11 illustrates a collecting component 38′ in accordance with yet another alternative embodiment of the invention. The embodiment shown in FIG. 11 is adapted to be used for collecting relatively small amounts of liquid waste such as menstrual blood losses. The collecting component 38′ includes a base sheet 164 preferably made out of a substantially flexible material. The base sheet 164 typically has a substantially frusto-triangular or rectangular configuration with rounded edges.

The base sheet 164 includes a main strap attachment means 62 located substantially adjacent one of its longitudinal ends and a substantially longitudinally opposed tail abutment edge 70 including an abutment edge apex 72 and a pair of laterally disposed edge abutment arms 74. An auxiliary strap attachment means 64 is formed in each of the edge abutment arms 74.

The base sheet 164 also typically defines thigh receiving lateral recesses 166. An absorbing pad 168 made out of a substantially liquid absorbent material such as used for conventional hygienic pads is permanently or releasably mounted to one of the surfaces of the base sheet 164 using suitable mounting means.

As illustrated throughout the Figures, the main and auxiliary strap attachment means 62, 64 typically include respectively main and auxiliary strap attachment apertures 126, 128 extending through the collecting component body. Optionally, at least one and possibly both the main and auxiliary strap attachment apertures 126, 128 may be provided with localization facilitating means positioned substantially adjacent thereto for facilitating the localization thereof.

For example, the peripheral edge of the main and auxiliary strap attachment apertures 126, 128 may be colored, textured or otherwise differentiated from the remainder of the collecting component body so as to facilitate localization thereof and, hence, so as to facilitate attachment thereto and removal therefrom of the attachment strap 42. Also, preferably, the main and auxiliary strap attachment apertures 126, 128 may be provided with aperture reinforcement means for reducing the risks of being torn.

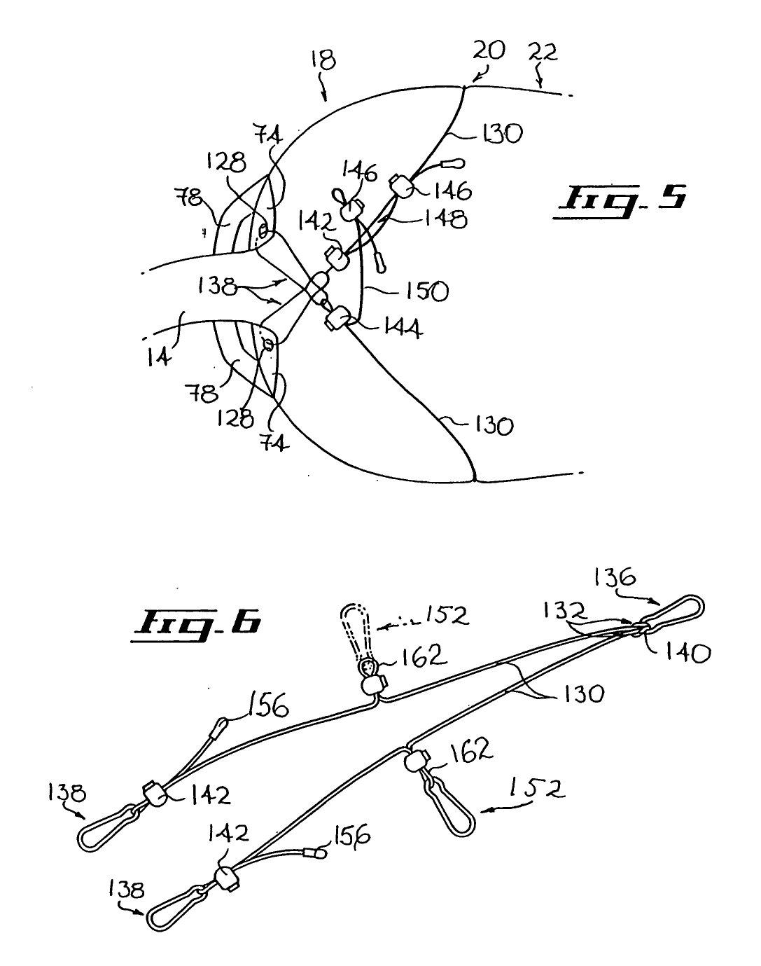

Referring now more specifically to FIGS. 4 and 6, there are shown some possible embodiments of attachment strap 42. Typically, the attachment strap 42 includes a pair of strap arms 130. Each strap arm 130 defines a strap arm first end 132 and an opposed strap arm second end 134. The strap arms 130 are typically coupled together about the strap arm first ends 132. Typically, the strap arms 130 extend integrally from each other, the attachment strap 42 being made out of an integral piece of material.

The attachment strap 42 has a main body attachment means located adjacent the strap first ends 32 and a pair of auxiliary body attachment means located adjacent each of the strap second ends 134. The body main and auxiliary attachment means are adapted to cooperate respectively with the main and auxiliary strap attachment means 62, 64 for releasably securing the attachment strap 42 to the collecting component body.

Typically, the main and auxiliary body attachment means includes respectively main and auxiliary hook-type components 136, 138. The main and auxiliary hook-type components 136, 138 are configured and sized so as to be insertable respectively into the main and auxiliary attachment apertures 126, 128. Typically, although by no means exclusively, the main and auxiliary hook-type components are of the “snap hook” type.

Typically, the attachment strap 42 is provided with length adjustment means for allowing selective adjustment of the length of at least one of the straps arms 130. Typically, the strap arms 130 are tied about the main knot 140 to the main hook-type component 136.

Typically, the strap arm second ends 134 are wrapped around the auxiliary hook-type components 138 and secured to the remainder of the respective strap arms 130 by friction-type strap locking components 142. The friction-type strap locking component 142 are provided with a trigger component 144 for allowing selective release of the frictional force exerted on the strap arms 130 so as to allow length adjustment thereof.

Typically, the attachment strap 42 is further provided with a strap arm positioning means for allowing selective adjustment of the relative position of the strap arms 130 relative to each other when the attachment strap 42 is operatively mounted n the animal 12. The strap arm positioning means typically includes an auxiliary locking component 146 allowing for the formation of an arm loop segment 148 about one of the strap arms 130.

The opposed strap 130 defines an insertable segment 150 releasably insertable into the loop segment 148. The loop segment 148 and the insertable segment 150 are adapted to cooperate with each other to restrain the relative spacing between the strap arms 130 adjacent to the strap arm second ends 134.

FIG. 6 illustrates an alternative embodiment of attachment strap 42′. The attachment strap 42′ is intended to be used particularly in situations wherein the loin region 22 and the hip region 20 are of substantially the same size such as is the case, for example, with obese animals having a poorly defined hip region 20. The attachment strap 42′ includes an auxiliary hook-type component 152 mounted on one of a pair of auxiliary loops 162 formed substantially intermediate the strap first and second ends 130, 134 of both strap arms 130.

FIGS. 19 through 24 illustrate a typical sequence of steps used for mounting the collecting component 38 to the animal 12 using an attachment strap 42. Typically, the main hook-type component 136 is initially attached to the main strap attachment aperture 126. As illustrated in FIG. 20, the strap arms 130 are then wrapped around the waist of the animal 12. One of the hook-type components 138 is attached to the opposite strap arm 130. In other words, one of the strap arms 130 is inserted within the opposite hook-type component 138.

When the collecting device 10 is used on a male animal, the strap arms 130 typically extend on each side of the penis. The main hook-type component 136 is typically located either behind the penis for castrated dogs, adjacent one of the groin areas 30 or in one of the groin areas 30.

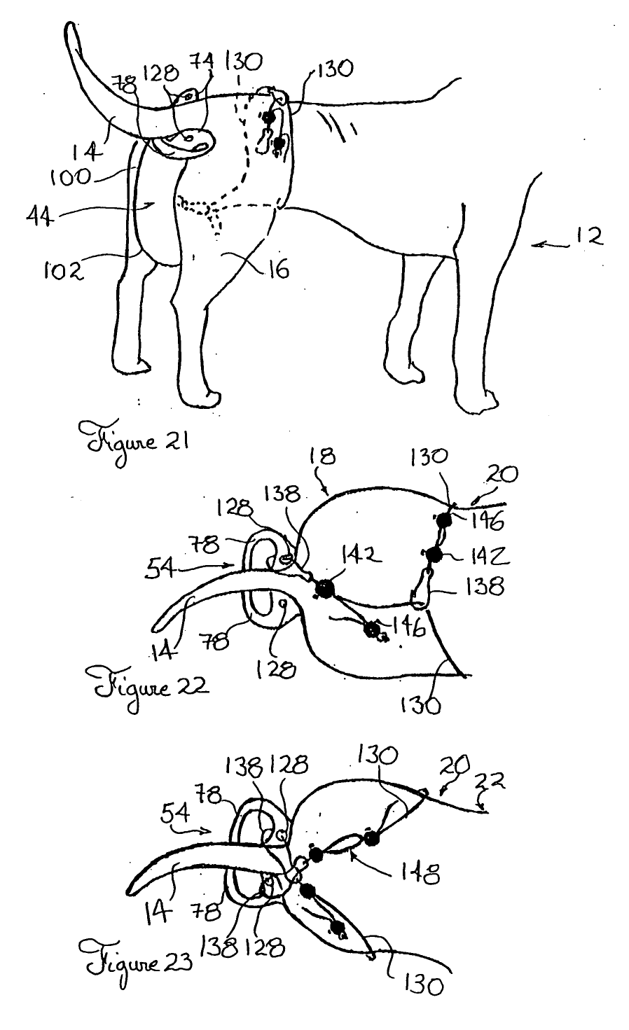

As shown in FIG. 21, the handle arms 78 are then folded back towards the handle folded configuration and the collecting component 38 is tilted towards its operational configuration wherein the tail 14 of the animal 12 is substantially fittingly inserted between the abutment edge arms 74.

As illustrated in FIG. 22, the yet unattached auxiliary hook-type component 138 is then attached to the auxiliary strap attachment aperture 128 located on the opposite side. The other auxiliary hook-type component 138 attached to the strap arm 130 is then detached from the strap arm 130 and attached to the unoccupied auxiliary strap attachment aperture 128 located on the opposite side.

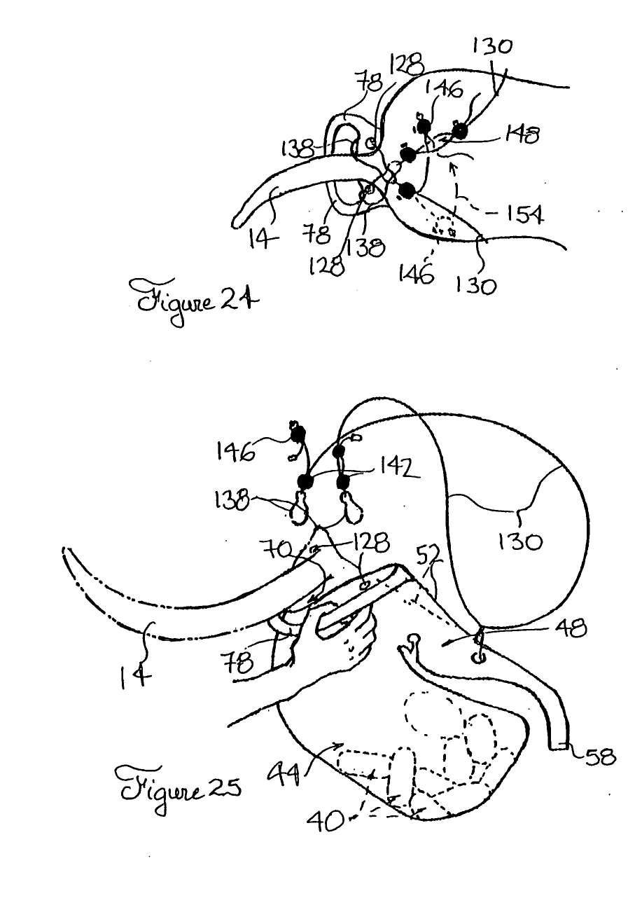

As shown in FIG. 23, the strap locking components 142 are then used to allow adjustment of the length of the strap arms 130 so as to insure that the tail 14 of the animal 12 is substantially snuggly inserted into the tail abutment edge 70. Preferably, the tension in the strap arms 130 is adjusted so as to be sufficient to maintain the collecting component 38 in proper operational position without being uncomfortable to the animal 12. Once the adjustment has been completed, terminal caps 156 may be fitted at the distal ends of the straps 130 such as shown in FIG. 4.

FIG. 24 illustrates an optional step that may be performed in order to maintain the strap arms 130 adjacent the hook-type component 138 in a relatively proximal relationship relative to each other. The step shown in FIG. 24 may be particularly useful in situations wherein the hip region 20 is not well-defined such as for obese dogs or the like. The insertable segment 150 is slidably inserted into the loop segment 148 as indicated by arrow 154. The position of the insertable segment 150 is illustrated in phantom lines while the position of the insertable segment 150 once inserted into the loop segment 148 is illustrated in full lines.

FIG. 25 illustrates some of the typical steps performed for removing the collecting component 38 from the animal 12. The handle arms 78 are initially grabbed by one hand of the intended user while the hook-type components 138 are removed from the auxiliary strap attachment apertures 128 with the other hand. The collecting component 38 is pulled rearwardly, thus facilitating access to the main hook-type component 136 which is removed from the main strap attachment aperture 126.

As shown in FIG. 15, the handle 54 and the second tab 58 are then tied together into a knot closing the peripheral edge aperture 50 so as to prevent the animal waste contained within the container section 44 from leaving the collecting component 38. The handle 54 may then be used for carrying the collecting component 38 containing the animal waste 40 to a suitable disposal location.

Alternatively, as illustrated in FIG. 7, when the collecting device 10 is being mounted on a dog 12 having a relatively poorly defined hip region 20, the attachment strap 42′ shown in FIG. 6 may be used. In such situations, the auxiliary hook-type component 152 is attached to the opposed auxiliary loop 162. Also, alternatively, when a collecting component 38 such as shown in FIG. 8 and 9 is used, an alternative attachment strap 42 having a pair of auxiliary strap segments 158 attached to a collar 160 may be used.

1. A collecting component for collecting animal waste, said collecting component being wearable by an animal having a tail, an anus, a tail root region extending between said tail and said anus, a perineum, a genital area, a pair of groin area, a pair of thighs, a hip area, a pubic area, a rump area, a loin area and an abdomen area; said collecting component being attachable to said animal using an attachment strap, said collecting component comprising:
a collecting component body made out of a substantially flexible material; said collecting component body defining a generally pouch-like container section for receiving said animal waste, said container section defining a container mouth leading thereinto, said collecting component body also defining a flange-like mounting section extending integrally from said container mouth for mounting said collecting component to said animal so as to collect at least part of said animal waste therefrom and so as to direct said at least part of said animal waste into said container section; said mounting section having a mounting aperture defining a mounting aperture peripheral edge; said mounting section peripheral edge being configured and sized for extending from said tail root region at least to said perineum so as to encompass at least said anus; said collecting component body also including
a first tab extending integrally from said mounting section, said first tab defining a first tab base positioned so as to be located substantially adjacent said tail root region;
a second tab extending integrally from said mounting section substantially opposite to said first tab, said second tab defining a second tab base;
a main strap attachment means formed in said collecting component body adjacent said second tab base for attaching a segment of said attachment strap thereto;
a pair of auxiliary strap attachment means formed in said collecting component body substantially adjacent said first tab base and spaced from each other for each attaching a corresponding segment of said attachment strap thereto;
whereby said first and second tabs are adapted to be used for manipulating said collecting component body and are also adapted to be tied together for substantially closing said mounting aperture.

2. A collecting component as recited in claim 1 wherein said mounting section defines
a mounting section first portion configured and sized for extending from said tail root region substantially across said anus and said perineum to substantially said genital area;
a mounting section second portion configured and sized for extending substantially across said genital area to substantially said pubic area.

3. A collecting component as recited in claim 2 wherein said second tab extends from said mounting section second portion, said second tab being configured and sized for extending substantially towards said pubic area.

4. A collecting component as recited in claim 2 wherein said mounting section second portion is in fluid communication with said container section for allowing animal waste originating from said genital area to flow into said container section.

5. A collecting component as recited in claim 2 wherein said mounting section second portion is in fluid communication with the exterior of said collecting component for allowing animal waste originating from said genital area to flow out of said collecting component.

6. A collecting component as recited in claim 1 wherein said mounting section is configured and sized so as to define a tail abutment edge for abutting against a portion of said tail root region.

7. A collecting component as recited in claim 6 wherein said tail abutment edge has a substantially “V”-shaped configuration defining an abutment edge apex and a pair of abutment edge arms extending from said abutment edge apex, each of said auxiliary strap attachment means being positioned on a corresponding abutment edge arm and being spaced from said abutment edge apex so that when said collecting component is mounted on said animal, said abutment edge apex is positioned in a proximal relationship with said tail adjacent said tail root region and at least a portion of each of said abutment edge arms is also in a proximal relationship relative to said tail respectively on substantially opposite sides of the latter.

8. A collecting component as recited in claim 7 further provided with apex reinforcement means positioned between said abutment edge apex and said container mouth for preventing the tearing of said container mouth upon a pressure being exerted by said tail on said abutment edge apex.

9. A collecting component as recited in claim 7 wherein said first tab is a loop handle, said loop handle defining a pair of handle arms merging together about a distally located handle apex, each of said handle arms extending from a corresponding one of said abutment edge arms about a corresponding abutment edge-to-handle transition area.

10. A collecting component as recited in claim 9 wherein said handle is foldable about said abutment edge-to-handle transition area between a handle folded configuration and a handle unfolded configuration wherein when said handle is in said handle folded configuration said handle arms are allowed to cross said abutment edge arms and said handle is positioned in a substantially overlying relationship relative to said container section.

11. A collecting component as recited in claim 9 wherein
said handle arms extend substantially along a handle axis when said handle is in said handle unfolded configuration;
said mounting aperture peripheral edge extends substantially along a peripheral edge axis; and,
said handle and peripheral edge axes define a handle-to-peripheral edge angle therebetween, said handle-to-peripheral edge angle having a value of approximately between ninety and one hundred and seventy degrees.

12. A collecting component as recited in claim 9 wherein said handle and said mounting aperture peripheral edge define a handle-to-peripheral edge intersection therebetween, said handle-to-peripheral edge intersection having a substantially concave and rounded configuration.

13. A collecting component as recited in claim 1 wherein said container section defines a guiding region extending from said container mouth, said guiding region extending in a flow-wise direction into a retaining region, said retaining region being located substantially underneath said guiding region when said collecting component is mounted on said animal; whereby said guiding region is adapted to guide said animal waste into said retaining region and said retaining region is adapted to retain said animal waste thereinto.

14. A collecting component as recited in claim 13 wherein said guiding and retaining regions are configured and sized so that said retaining region extends at least partially between said thighs when said collecting component is mounted on said animal.

15. A collecting component as recited in claim 14 wherein said mounting aperture peripheral edge extends substantially along a peripheral edge axis and said retaining region extends substantially along a retaining section axis; said peripheral edge and retaining section axes being angled relative to each other by a peripheral edge-to-retaining section angle, said peripheral edge-to-retaining section angle having a value of approximately between five and eighty degrees.

16. A collecting component as recited in claim 13 wherein said guiding region defines a guiding region outer edge, said guiding region outer edge extending integrally from said abutment edge apex to a position located in a substantially opposed relationship relative to said container mouth, said guiding region outer edge having a substantially rounded configuration.

17. A collecting component as recited in claim 16 wherein said mounting section defines a mounting section first portion configured and sized for extending from said tail root region substantially across said perineum to substantially said genital area and said mounting section also defines a mounting section second portion configured and sized for extending substantially across said genital to substantially said pubic area; said retaining region defining a retaining region outer edge extending integrally from said guiding region outer edge and a retaining region inner edge located substantially adjacent to said mounting section second portion; said retaining region outer edge having a substantially rounded configuration and said retaining region inner edge extending substantially from said retaining region outer edge to said container mouth and having a substantially rectilinear configuration.

18. A collecting component as recited in claim 1 wherein said container section is deformable by said animal waste as said animal waste penetrates into said container section, said container section being deformable from a container retracted configuration to a container expanded configuration wherein the volume of said container section is smaller when said container section is in said container retracted configuration then when said container section is in said expanded configuration.

19. A collecting container as recited in claim 18 wherein said container section is made out of a substantially resiliently deformable material.

20. A collecting container as recited in claim 18 wherein said container section is foldable substantially about one of its edges into said container retracted configuration.

21. A collecting container as recited in claim 18 wherein said container section is shrinkable.

22. A collecting component as recited in claim 1 wherein said mounting section defines
a mounting section first portion configured and sized for extending from said tail root region substantially across said perineum to substantially said genital area;
a mounting section second portion configured and sized for extending substantially across said genital to substantially said pubic area;
a mounting section inner edge located substantially opposite to said mounting section peripheral edge in the region of said mounting section second portion.

23. A collecting component as recited in claim 22 wherein said mounting section inner edge prevents the flow of said animal waste therethrough.

24. A collecting device as recited in claim 22 wherein said mounting section inner edge is provided with an inner edge slot extending therethrough, said mounting section second portion defining a pair of second portion arms; whereby each of said second portion arms is positionable in a corresponding one of said groin areas with at least a portion of said genital area positionable substantially in register with said inner edge slot.

25. A collecting device as recited in claim 24 further comprising corner

26. A collecting device as recited in claim 22 wherein said mounting section second portion defines an organ receiving pocket, said organ receiving pocket being in fluid communication with said retaining region; whereby said organ receiving pocket is adapted to receive a penis of said animal.

27. A collecting device as recited in claim 22 further comprising a mouth reinforcement means located intermediate said container mouth and said mounting section inner edge for preventing tearing of said container mouth.

28. A collecting device as recited in claim 1 wherein said main and auxiliary strap attachment means include respectively main and auxiliary strap attachment apertures extending through said collecting component body.

29. A collecting device as recited in claim 28 further comprising localization facilitating means positioned adjacent at least one of said main and auxiliary strap attachment apertures for facilitating the localization of said at least one of said main and auxiliary strap attachment apertures.

30. A collecting component as recited in claim 1 wherein said attachment strap has a pair of strap arms, each of said strap arms defining a strap arm first end and an opposed strap arm second end, said strap arms being coupled together about said strap arm first ends, said attachment strap having a main body attachment means located adjacent said strap arm first ends and a pair of auxiliary body attachment means located adjacent each of said strap second ends; whereby said body main and auxiliary attachment means are adapted to cooperate respectively with said main and auxiliary strap attachment means for releasably securing said attachment strap to said collecting component body.

31. A collecting component as recited in claim 30 wherein said main and auxiliary strap attachment means respectively include main and auxiliary attachment apertures extending through said collecting component body and said main and auxiliary body attachment means include respectively main and auxiliary hook-type components insertable respectively into said main and auxiliary attachment apertures.

32. A collecting component as recited in claim 30 further comprising a length adjustment means for allowing selective adjustment of the length of at least one of said strap arms.

33. A collecting component as recited in claim 31 further comprising a strap arm positioning means for allowing selective adjustment of the relative position of said strap arms when said attachment strap is operatively mounted on said animal.

34. A collecting device for collecting animal waste, said collecting device being wearable by an animal having a tail, an anus, a tail root region extending between said tail and said anus, a perineum, a genital area, a pair of groin area, a pair of thighs, a hip area, a pubic area, a rump area, a loin area and an abdomen area; said collecting device comprising:
a collecting component defining a generally pouch-like container section for receiving said animal waste, said container section defining a container mouth leading thereinto, said collecting component body also defining a flange-like mounting section extending integrally from said container mouth for mounting said collecting component to said animal so as to collect at least part of said animal waste therefrom and so as to direct said at least part of said animal waste into said container section; said mounting section being configured and sized so as to define a tail abutment edge for abutting against a portion of said tail root region;
an attachment strap attachable to said collecting component for releasably securing said collecting component to said animal.

35. A collecting device as recited in claim 34 wherein said attachment strap is configured and sized for securing said collecting component to said animal so that said mounting section encompasses said anus and said tail abutment edge is in a substantially proximal relationship with the base of said tail.

36. A collecting device as recited in claim 34 wherein said tail abutment edge has a substantially “V”-shaped configuration defining an abutment edge apex and a pair of abutment edge arms extending from said abutment edge apex; said collecting component also including a main strap attachment means and a pair of auxiliary strap attachment means formed therein; said attachment strap defining a pair of strap arms, each of said strap arms defining a strap proximal end and a strap distal end; said attachment strap being attachable to said collecting component so that said strap proximal ends are attached to said main strap attachment means and each of said strap distal end is attached to a corresponding one of said auxiliary strap attachment means.

37. A collecting device as recited in claim 36 wherein said attachment component and said attachment strap are configured and sized so that said strap proximal ends and said main strap attachment means are positioned substantially adjacent said pubic area while said strap distal ends and said auxiliary strap attachment means are located substantially adjacent said tail root area substantially on opposite sides of said tail when said collecting component is mounted on said animal using said attachment strap.

38. A collecting device as recited in claim 37 wherein said attachment component and said attachment strap are configured and sized so that each of said strap arms extends from a corresponding one of said groin areas across said hip area towards said tail root area on a side of said tail opposite to that of said corresponding one of said groin area when said collecting component is mounted on said animal using said attachment strap; whereby said strap arms cross each other substantially in said rump area substantially adjacent to said tail when said collecting component is mounted on said animal using said attachment strap.
